(19) United States
(12) Patent Application Publication
(10) Pub. No.: US 2005/0262909 A1
(43) Pub. Date: Dec. 1, 2005

(54) Motorcycle security device

(76) Inventor: Gary Leslie Brooks, Moorebank (AU)

Correspondence Address: MICHAEL MOLINS;MOLINS & CO., SUITE S, LEVEL 6, 139 MACQUARIE ST, SYDNEY NSW, 2000, AU

(21) Appl. No.: 11/104,454

(22) Filed: Apr. 13, 2005

(30) Foreign Application Priority Data
Apr. 22, 2004 (AU) 2004902144

(51) Int. Cl. E05B 71/00

(52) U.S. Cl. 70/227; 70/235

(57) ABSTRACT

A stand and security device is provided for a motorcycle. It is formed from a generally “J” shaped frame. The frame is shaped as a channel having a “U” shaped cross-section. A forward portion of the frame forms a stop or barrier. The forward or rear sidewall portions of the frame have one or more aligned pairs of through openings for receiving a locking mechanism. The frame channel has a bottom surface that has through openings so that the stand can be attached to a ground surface or to a trailer.

### FIELD OF THE INVENTION

The invention pertains to security devices and more particularly to a device for securely locking a motorcycle. The device may be used in a variety of ways including by affixing it to a specific location or my mounting it on a trailer.

### BACKGROUND OF THE INVENTION

Motorcycles are frequently secured by use of a lock and chain. By passing the chain (or the like) through the wheels of a motorcycle, the vehicle can be effectively disabled. However, the vehicle may be transported from its location because (compared to a car) it is small and light. It is also known to affix a motorcycle to a stationery object with a chain and lock. Using this method, it is still possible to sever the chain. Hardware used for this purpose makes little or no contribution to the upright, standing stability of the motorcycle.

### OBJECTS AND SUMMARY OF THE INVENTION

Accordingly, it is an object of the present invention to provide a device to which a motorcycle can be securely affixed. In preferred embodiments of the invention, the device contributes to the upright, standing stability of the motorcycle.

In other preferred embodiments, the device is advantageously secured to a ground surface in a way that discourages vandalism.

One embodiment may be adapted to receive a variety of motorcycles.

In one particular embodiment, an adjustable portion slides on cylindrical rails so that a variety of wheelbase lengths can be accommodated.

### BRIEF DESCRIPTION OF THE DRAWING FIGURES

FIG. 1 is a perspective view of a motorcycle security device fabricated in accordance with the teachings of the present invention;

FIG. 2 is a perspective view of the device shown in FIG. 1, with a motorcycle in place;

FIGS. 3(a) and (b) are top and side views of a device according to the teachings of the present invention;

FIG. 4 is a plan view of a manufacturing precursor to the device depicted in FIGS. 3(a) and (b);

FIG. 5 is a side elevation of a front portion of a device according to the teachings of the invention;

FIG. 6 is a perspective view of a device particularly adapted to secure an off-road motorcycle;

FIG. 7 is a perspective view of a device particularly adapted to receive a larger motorcycle;

FIG. 8 is a perspective view of the device depicted in FIG. 7, showing the adjustable rear portion;

FIG. 9 is a perspective view of a security housing according to the teachings of the invention;

FIG. 10 is a side elevation of a locking device in use, showing the security housing and locking pin together with a lock;

FIG. 11 illustrates a locking pin passing between the sides of a channel section according to the teachings of the present invention; and

FIG. 12 is an exploded perspective view of a trailer fabricated according to the teachings of the present invention.

### BEST MODE AND OTHER EMBODIMENTS OF THE INVENTION

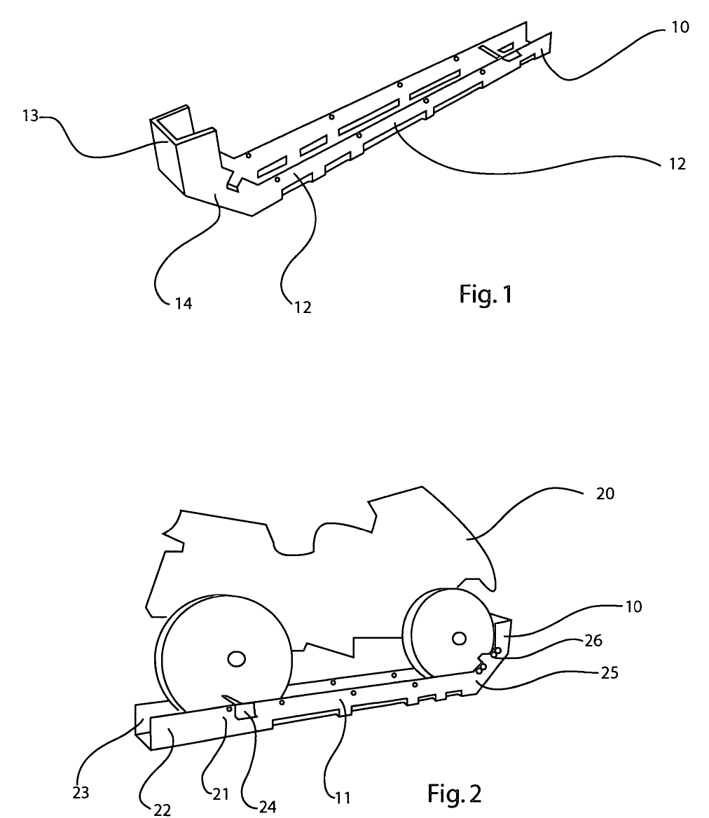

As shown in FIG. 1, a motorcycle security device 10 comprises a generally “J” shaped steel channel 11 having a “U” shaped cross-section. The main section 12 of the channel is generally flat and adapted to contact the ground. It may be attached to the ground by anchor bolts located below the point where the wheels of a motorcycle would overlie if a motorcycle were being used with the device. The upright or forward portion of the channel 13 forms a stop or barrier that prevents a motorcycle from advancing. An angled intermediate section 14 connects the main section 12 and the upright section 13.

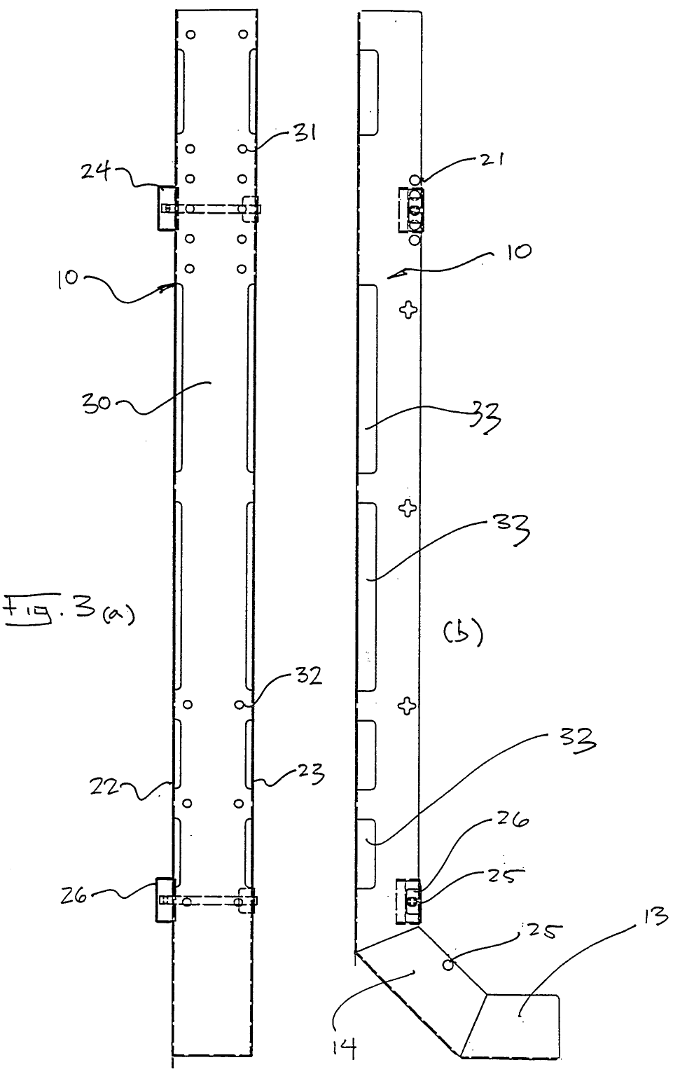

FIG. 2 illustrates the device 10 being used with a motorcycle 20. As shown in this figure, a rear portion of the main section 11 includes pairs of through holes 21 which are formed, in alignment, through each side of the channel 22, 23. These pairs of aligned through holes 21 allow a locking system 24 to pass through the rear wheel of the motorcycle 20 and lock it in place. Similar pairs of forward located holes 25 are used with a separate locking system 26 to lock the front wheel of the motorcycle 20 to the device 10.

As shown in FIG. 3a, the bottom surface 30 of the channel is drilled with forward and rear holes 31, 32 which may be used for securing anchor bolts which are preferably used to secure the device 10 on a ground surface or trailer. Bottom openings 33 along various locations in one or both side walls 22, 23 reduce the weight of the device and allow water in the channel to escape.

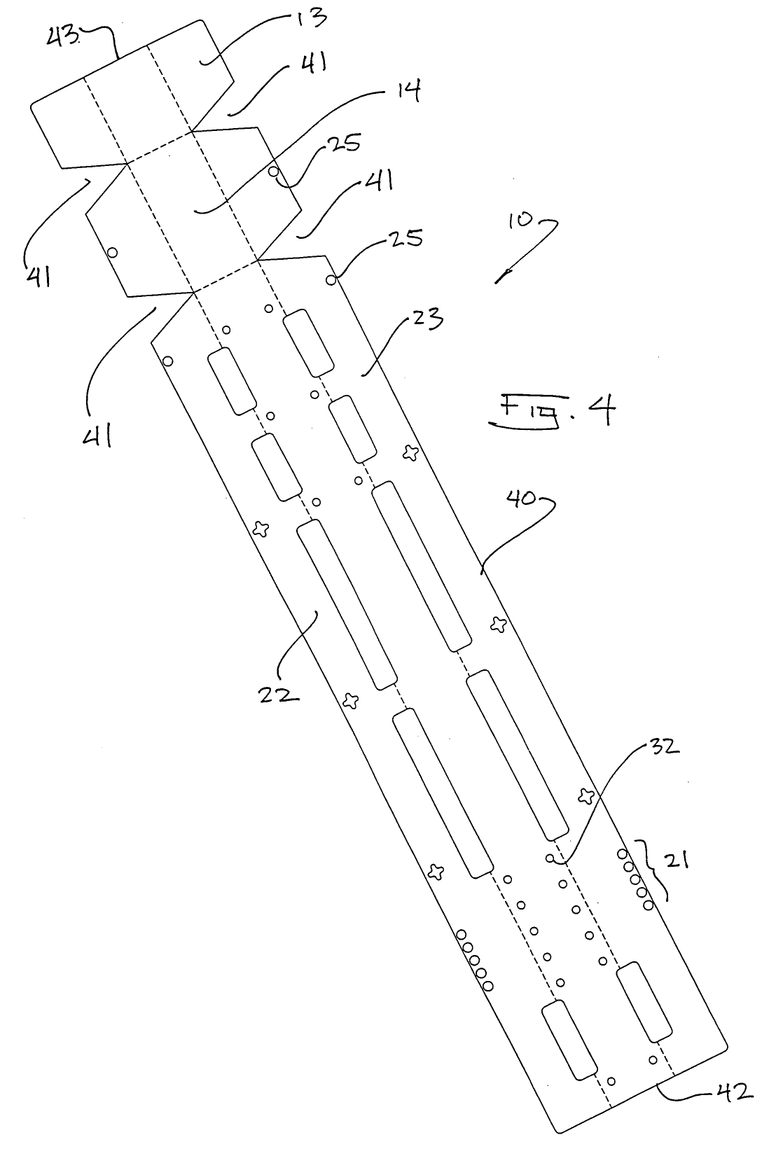

As shown in FIG. 4, the device 10 may be fabricated from a flat piece of punched and drilled steel 40 in which the various features are formed prior to bending. Relieve areas 41 formed in each of the side walls 22, 23 allow the side walls to extend continuously from the rear end 42 to the front end 43 after the metal bending operations are complete.

It will be appreciated that a wide variety of locations may be employed for the provision of various features such as bottom attachment holes 32, rear located locking holes 21, forward locking holes 25, relief areas 41 and exit openings 32. Accordingly, using these teachings, a device of this type may be provided with features that are specifically adapted to a single motorcycle, to a narrow range of motorcycle types or to a wide variety of motorcycle types and measurements.

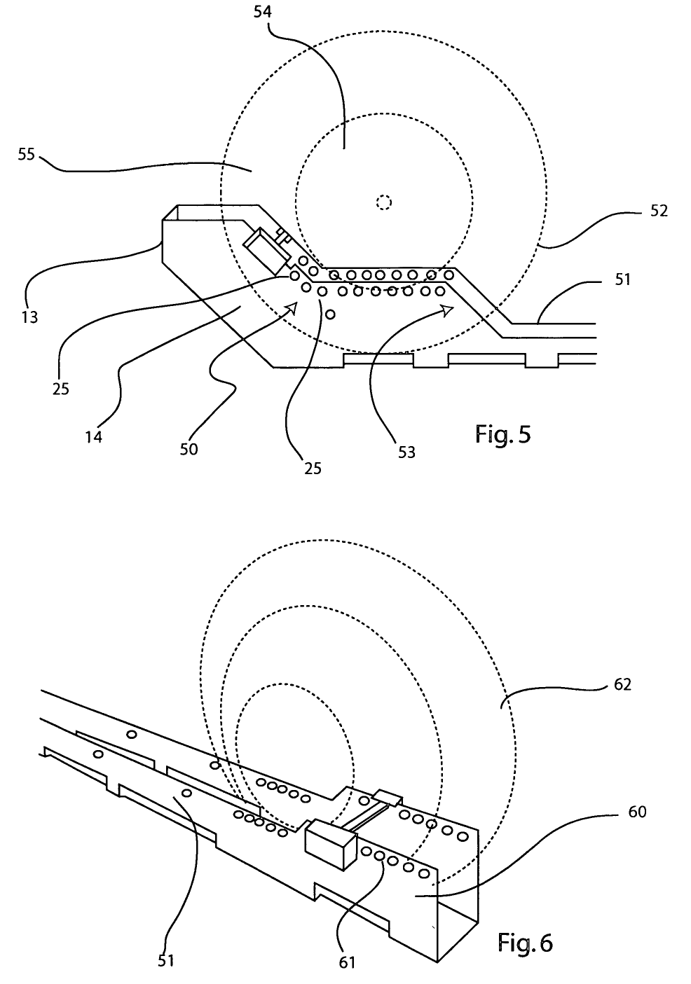

For example, and as shown in FIG. 5, a particular front end 50 is adapted for motorcycles with large front tires such as the Harley Davison brand motorcycle. In this example, the upright portion 13 is somewhat reduced in size. Similarly, the front locking openings 25 are elevated above the top edge of the main channel 51 to accommodate motorcycle tires 52 which are bigger than normal. The extra material above the upper edge 51 of the channel forms a wing 53 that in some embodiments fits between a motorcycle's disc brake 54 and the exterior surface of the rim 55. If required, openings 25 may be provided along all or part of the upper edge of the wing and/or intermediate portion 14 to provide more variety of attachment points for these large wheels.

Another embodiment is depicted in FIG. 6. Here extra material above the to edge 51 forms a rear wing 60 that includes a plurality of openings 61 which are elevated above the upper surface 51 of the main channel to accommodate the large tires 62 found on off-road bikes.

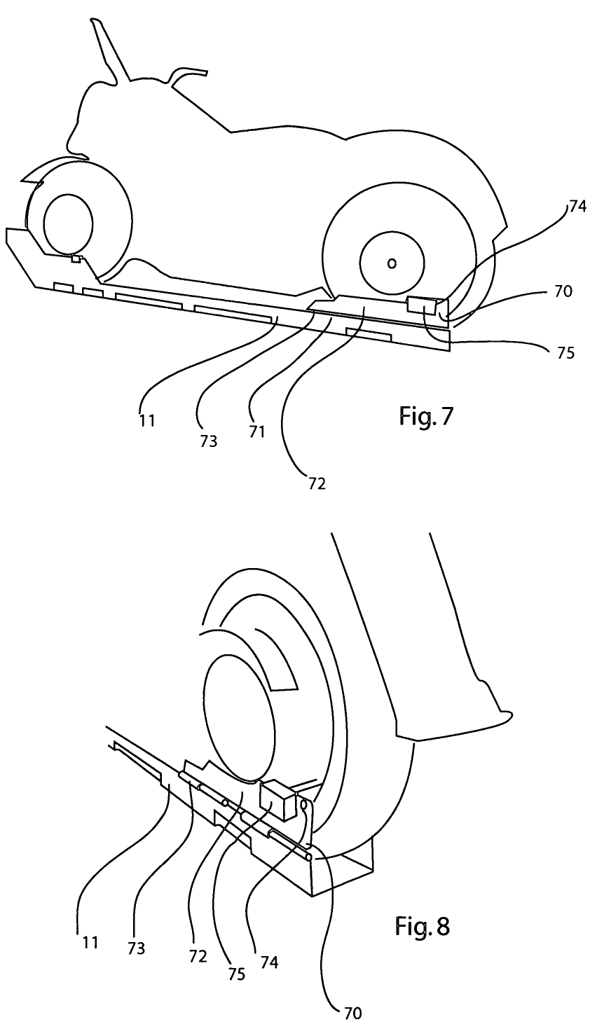

Another feature which may be optionally provided is an adjustable or telescopic rear mounting portion 70 as shown in FIGS. 7 and 8. In this embodiment cylindrical and preferably hardened steel rails 71 are joined to the channel 11. In this way a sliding wing portion 72 may be provided with journals 73 that are adapted to slidably receive the rods 71. In this way the rear pairs of through holes 74 may be adjusted with respect to the location of the front wheel so as to accommodate bikes with particularly long wheelbases. The same feature also facilitates the accommodation of a variety of rear wheel styles in that the adjustment feature allows the location of the rear locking device 75 to be positioned with a great deal of flexibility and discretion by the user.

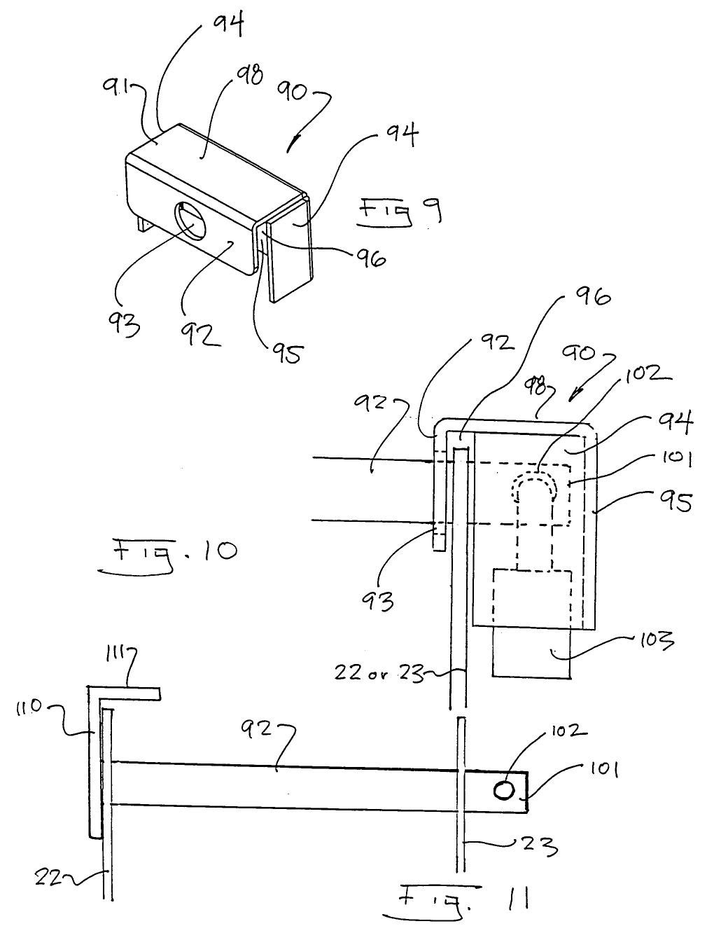

As shown in FIGS. 9-11, a locking device 90 comprises a protective security housing 91 and a locking pin 92. A locking device 90 of this type is particularly useful for locking a wheel of a motorcycle to the side channel structures of the present invention. The housing 91 comprises a faceplate 92 in which is formed a through opening 93. The housing 91 also includes a top surface 98, protective sidewalls 94 and a backing plate 95. A gap 96 between the face plate 92 and the edge of each sidewalls 94 is adapted to receive the upper edge of a side of the channel (either 22 or 23). As shown in FIGS. 10 and 11, the locking pin 92 may be inserted through an opening in a side wall 22 and pass through a co-operating opening in the opposite side wall 23. The head 110 of the locking pin 92 prevents the pin from advancing. The free end 101 of the pin 92 passes through the opening 93 in the housing's face plate 92 before entering the opposite side wall 23. As shown in FIG. 10, this locates the through hole 102 formed in the free end 101 of the pin 92 within the protective housing 90. In this position, a lock 103 may be inserted through the opening or hole 102 and secured. The side walls 94, backing plate 95, upper surface 98 and channel side wall 23 all contribute toward protecting the lock 103 from tampering and weather.

Note that the head 110 of the locking pin 92 includes “L” shaped protective section 111 that extends laterally or parallel with the pin 92 and covers a section of the sidewall 22 that is located above the pin 92. This discourages tampering with the shank of the pin 92 in the area below the protective cap 111.

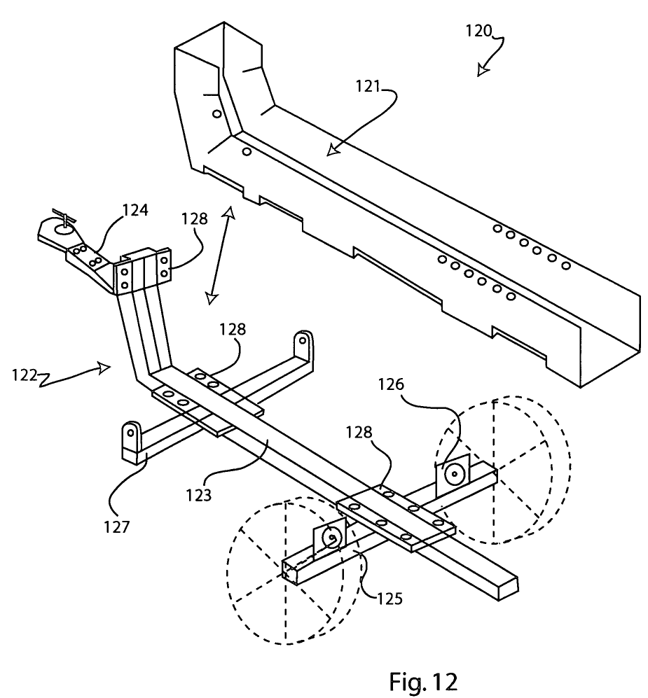

As shown in FIG. 12, a trailer 120 may be fabricated by attaching a “J” shaped channel 121 of the type depicted in drawing FIGS. 1-8 with a trailer chassis 122. In preferred embodiments, the chassis 122 comprises a primary longitudinal support 123 which steps up to an attachment neck 124. The primary support 123 has attached to it, for example, a square tubular axle support 125. In some embodiments, the axle support 125 is adapted to suit a dura-torque ™ type axle. The absence of leaf coils springs in this type of axle mechanism allows the centre of gravity of the trailer to be minimized. The axle support 125 can also be used to attach taillights 126 and a number plate, as required. Laterally extending tie-down supports 127 may be provided forward of the main axle. Drilled through mounting plates 128 may be used to affix the channel 121 to the trailer chassis 122. In this way, a trailer chassis 122 may be used to receive a variety of different channel members 121.

While the present invention has been disclosed with reference to particular details of construction, these should be understood as having been provided by way of example and not as limitations to the scope of spirit of the invention as discussed above. In particular, the invention is not considered to be limited to particular dimensions, proportions or uses.

1. A stand and security device for a motorcycle, comprising:
a generally “J” shaped frame formed from a channel having a “U” shaped cross-section;
a forward portion of the frame forming a stop or barrier;
the forward or rear sidewall portions having one or more aligned pairs of through openings for receiving a locking mechanism.

2. The stand of claim 1, wherein:
a rear portion of the frame has one or more aligned pairs of through openings for receiving a second locking mechanism.

3. The stand of claim 1, wherein:
the frame channel has a bottom surface that has through openings so that the stand can be attached to a ground surface.

4. The stand of claim 1, wherein:
the “J” shaped frame channel is fabricated from a single piece of steel in which is formed through openings and relief areas that facilitate fabrication.

5. The stand of claim 1, wherein:
the forward portion further comprises an angled intermediate section.

6. The stand of claim 1, wherein:
a rear portion of the frame further comprises lateral and opposing wing areas.

7. The stand of claim 6, wherein:
the wing areas are formed with one or more pairs of opposed through openings for receiving a locking mechanism.

8. The stand of claim 1, further comprising:
a locking mechanism that forms a protective security housing having a face plate in which is formed a through opening adapted to receive a pin, a top surface, a pair of side walls and a backing plate;
there being a gap between the face plate and an edge of each side wall adapted to receive an upper edge of the frame.

8. The stand of claim 8, further comprising:
a locking pin that fits through the through opening adapted to receive a pin, the pin having a head at one end and an opening for a lock at the other end.

9. The stand of claim 1, wherein:
the stand is affixed to a trailer having a chassis and wheels.

10. The stand of claim 9, wherein:
the suspension is of a type lacking leaf or coil springs.
